(19) United States
(12) Patent Application Publication
(10) Pub. No.: US 2008/0134969 A1
(43) Pub. Date: Jun. 12, 2008

(54) Powder coating cabin for a powder coating installation

(75) Inventors: Wolfgang Bezner, Schoenaich (DE); Joerg Pfau, Stuttgart (DE); Norbert Strasser, Gechingen (DE); Joachim Rudolf, Schoenaich (DE)

Correspondence Address: FACTOR & LAKE, LTD, 1327 W. WASHINGTON BLVD., SUITE 5G/H, CHICAGO, IL, 60607, US

(73) Assignee: EISENMANN ANLAGENBAU GMBH & CO. KG, Boeblingen (DE)

(21) Appl. No.: 11/998,995

(22) Filed: Dec. 3, 2007

(30) Foreign Application Priority Data
Dec. 7, 2006 (DE) 10 2006 057 696.9

(51) Int. Cl. B05C 11/00

(52) U.S. Cl. 118/504

(57) ABSTRACT

A powder coating cabin for a powder coating installation comprises a flat floor section arranged horizontally or inclined, and a blow-off nozzle for blowing off powder that has settled on the floor section. According to the invention the blow-off nozzle is movably arranged, and in particular preferably parallel to the floor section. As a result of the movability a relatively large floor section can be freed from powder very effectively using only one blow-off nozzle.

### RELATED APPLICATIONS

This application claims the benefit of German Patent Application No. 10 2006 057 696.9, filed Dec. 7, 2006; the contents of which all are incorporated herein by reference.

### TECHNICAL FIELD

The present invention relates to a powder coating cabin for a powder coating installation with a flat floor section arranged horizontally or inclined and with a blow-off nozzle for blowing away powder that has settled on the floor section.

### BACKGROUND OF THE INVENTION

Such a powder coating cabin is known from EP 1 466 670 A2.

In the electrostatic powder coating of objects powder is sprayed from a powder spraying device onto the objects to be coated. The spraying process takes place in a powder coating cabin, into which the objects are introduced with the aid of a conveying system and from which they are removed after the coating.

In the coating process not all powder particles sprayed from the powder spraying device adhere to the object to be coated. The excess powder, which is termed overspray, settles on the internal cladding, and more particularly on the floor of the powder coating cabin, and has to be removed therefrom. It is necessary to remove the excess powder in the first place, since if a cloud of powder dust accumulates in the cabin there is the danger of an explosion if a specific concentration of powder is exceeded. Another reason for removing the excess powder lies in the fact that the cleaning measures which are necessary when changing the colour will then take up significantly less time.

In order to remove excess powder it is known to provide one or more suction channels underneath or in the vicinity of the floor of the powder coating cabin. Excess powder is aspirated from the floor region through generally slit-shaped suction openings, which extend along the longitudinal direction of the powder coating cabin and adjoin the suction channels.

The most favourable conditions exist if the floor surfaces have a relatively large slope, since then at least some of the excess powder slides off under the action of gravity downwardly into a channel or the like, from which the powder can then be aspirated without any problem.

The situation is more complicated if horizontal or only slightly inclined floor sections are also provided. Such floor sections are necessary inter alia if access by foot to the powder coating cabin is to be provided. Such access by foot is convenient not only if the powder spraying devices are manually operated, but also facilitates the cleaning and maintenance of the powder coating cabin. On horizontal floor sections fallen powder cannot however slide off under the action of gravity and accumulate at a site, from which it can then easily be aspirated. Accordingly the fallen powder has to be aspirated with a relatively high suction efficiency from the horizontal floor sections.

In order to keep the suction force within reasonable limits, EP 1 125 639 B1 proposes that the horizontal floor section extending in the longitudinal direction of the powder coating cabin should be kept as narrow as possible. The horizontal floor section is bounded along its longitudinal sides by metal slide-off sheets, which form an angle of about 45° with the horizontal. Vertical side walls of the powder coating cabin join onto the top of the metal slide-off sheets. A suction channel runs in each case underneath each metal slide-off sheet in order to aspirate the powder that has fallen down.

From DE 103 50 332 A1 a powder coating cabin is known in which a suction channel runs underneath the floor of the powder coating cabin. The floor is in this case formed by flaps arranged parallel to one another, which can rotate about axes of rotation parallel to the longitudinal axis of the powder coating cabin. The longitudinal edges of the flaps demarcate suction slits, through which the powder that has fallen down can be aspirated.

In order to remove as completely as possible fallen powder, it has been proposed to provide in addition to the suction slits also blow-off devices which direct a stream of air onto horizontal or also inclined floor sections, in such a way that powder deposited thereon is blown off in the direction of the suction slits.

Blow-off devices of this type are known for example from EP 1 466 670 A2 already mentioned in the introduction. The powder coating cabin described there is of similar construction to the powder coating cabin known from EP 1 125 639 B1 mentioned above. In addition however, first air blowing strips are arranged there directly above inclined metal slide-off sheets. These first air blowing strips blow powder which has fallen onto the metal slide-off sheets, onto the horizontal floor section, which is enclosed by the two metal slide-off sheets. Second air blowing strips extend in the middle of the horizontal floor section, which blow powder that has fallen onto the floor section sideways onto lateral suction slits adjoining suction channels.

A powder coating cabin known from DE 10 2004 059 602 A1 has a similar structure to the powder coating cabin that is known from EP 1 125 639 B1. The middle part of the horizontal floor section cannot however swivel in this case. Instead, blow-off nozzles are arranged there in order to blow off powder that has fallen onto this part into suction slits.

The approaches described above, in which blow-off nozzles blow fallen powder in the direction of a suction slit, have disadvantages in many respects. In order to remove fallen powder as completely as possible, the air has to flow from the blow-off nozzles under very high pressure. Furthermore, on account of their limited range a large number of blow-off nozzles are required in order to free from powder as completely as possible all surfaces on which powder has settled.

The present invention is directed to address these and other issues.

### SUMMARY OF THE INVENTION

One object of the present invention is to provide a powder coating cabin, in which with simple means it is possible to achieve a very thorough removal of powder that has settled on a horizontal or inclined flat floor section.

According to the invention this object may be achieved in a powder coating cabin of the type mentioned in the introduction if the blow-off nozzle is movably arranged.

The invention is based on the knowledge that it is not at all necessary during the overall coating procedure to constantly blow off, in the direction of a suction opening, powder that has settled on the floor section. Instead, it is sufficient if the powder is blown off intermittently from the floor section by the blow-off nozzle, and in particular preferably at regular intervals.

Instead of having to provide a plurality of blow-off nozzles which discharge compressed air only intermittently, according to the invention at least one blow-off nozzle is provided, which is movably arranged. On account of its movability the blow-off nozzle can free the whole floor section or at least a major part thereof from powder. The blowing off action is now however considerably more uniform than would be the case with intermittently operating stationary blow-off nozzles.

The nozzle movement preferably takes place continuously at a constant speed, since in this way the most uniform blow-off effect is achieved. In individual cases however a mode of operation at different speeds, intermittent interruptions of the movements, or also (brief) changes of direction may be advisable. Such non-uniform of movements are adopted for example if in the region of the floor section there are upwardly projecting obstacles, for example parts of spray robots, which necessitate a renewed or longer blow-off action. Furthermore it is possible to monitor the floor section by means of a camera and determine the cleaning effect by image-processing methods. The blow-off nozzle is then driven until the desired cleaning effect is achieved.

The blow-off effect is particularly uniform if the blow-off nozzle is movable parallel to the floor section. In general the movement path will then also lie on a horizontal straight line. In the case of inclined floor sections inclined movement paths are however also possible.

With regard to an optimal blow-off effect, it is advisable if the shortest distance between an outlet opening of the blow-off nozzle and the floor section is less than 5 cm, preferably less than 2 cm. Such a small distance between the blow-off nozzle and the horizontal floor section ensures that the air stream exiting from the blow-off nozzle is guided as far as possible directly over the surface of the floor section. If the blow-off nozzles were arranged at a greater height above the floor section, the blow-off effect would be less since the air stream has already lost some of its energy due to turbulence phenomena.

The action of the blow-off nozzle can be further optimised if the nozzle can in addition be swivelled about a horizontal and/or vertical pivotal axis. A swivelling about a horizontal pivotal axis is particularly convenient if the blow-off nozzle is not directly arranged above the floor section, as has been discussed hereinbefore. If the blow-off nozzle is further from the floor section, for example at a distance of 20 cm or 40 cm, then the exiting air stream can be directed by a swivelling movement onto regions that are closer to or further away from the blow-off nozzle. If necessary, it may in this connection be advisable to interrupt the air stream all the while the blow-off nozzle is swivelled downwards. In this way powder is prevented from being sucked up into the blow-off nozzle by turbulence effects. A swivelling movement about a vertical pivotal axis may for example be advantageous in order to enable the air stream exiting from the blow-off nozzle to reach more effectively edge regions at the end of the movement path.

In another preferred modification of the invention the blow-off nozzle is movable parallel to a transporting direction towards objects to be coated. This is advantageous since the dimensions of the powder coating cabin along this direction are as a rule substantially larger than in the transverse direction. A horizontal flat floor of shorter and not too wide powder coating cabins can then possibly be “blown” with only one blow-off nozzle. In order that the blow-off intervals do not become too long, it may be advisable in the case of longer powder coating cabins to arrange a plurality of movable blow-off nozzles behind one another in the longitudinal direction.

In the case of wider powder coating cabins it may be convenient on account of the limited range of the air stream generated by the blow-off nozzles to provide at least two blow-off nozzles, whose movement paths run parallel to one another and to the transporting direction of the objects to be coated. Each blow-off nozzle then removes the fallen powder over about half the width of the floor section.

There are various possibilities as regards the position of the movement path in the transverse direction of the powder coating cabins. Thus, the movement path of the blow-off nozzle can be arranged in a transition region between the floor section and a vertical side wall of the powder coating installation. This is advantageous since there is generally more space in the region of the side wall for the movement path. With particularly narrow powder coating cabins a suction slit on the oppositely facing side is then sufficient in order to be able to completely clean the floor section of powder.

With wider powder coating cabins it is as a rule more convenient to provide at least one movable blow-off nozzle on each longitudinal side of the powder coating cabin. The powder blown towards the middle of the powder coating cabin can then be aspirated via a suction channel arranged there.

In a variant the movement path of the blow-off nozzle runs at least approximately in the middle between vertical side walls of the powder coating cabin. During the movement operation the blow-off nozzle then blows excess powder towards a side wall, from where it is aspirated via a suction channel. On the return path the blow-off nozzle can be rotated for example by 180°. Alternatively, a blow-off nozzle can also be used which can eject air in all directions or at least in two opposite directions. In this way powder is blown to both sides of the powder coating cabin during a movement operation. Obviously it is also possible to arrange the movement paths of two blow-off nozzles close to one another in the middle of the powder coating cabin. Each blow-off nozzle then cleans one half of the floor section.

With particularly wide powder coating cabins movement paths for blow-off nozzles can be arranged along the vertical side walls as well as along the middle.

Irrespective of the arrangement of the movement path, it is convenient if the blow-off nozzle projects from a slit at least over part of the possible movement path. In this way the feed line and the drive for the blow-off nozzle are protected against falling powder.

The protective effect can be improved further if the slit is covered by an elastic slit strip that can be displaced or penetrated by the blow-off nozzle. Suitable for example are rubber lips or rows of bristles, which prevent penetration of powder into the gap between the inner wall and outer wall of the powder coating cabin.

The slit can for example be formed with different angles of inclination between the floor and wall sections. In this case a slit can be formed particularly easily since in any case a plurality of metal sheets of the inner lining adjoin one another there.

The suction channel can be covered at least in part over its whole length by a covering, in such a way that suction slits remain between the covering and adjoining horizontal floor sections. A covering is advantageous since in this way access to the suction channel for maintenance and cleaning work is created. The covering can for example be made so that it can be removed or swivelled open.

If the suction channel runs centrally underneath the floor of the powder coating cabin, it has proved convenient if the covering has a convexly outwardly curved outer surface. If the covering is suitably designed, then no powder can accumulate in the middle of the covering.

An optimal effect is achieved if a ridge line of the outer surface runs at the same height as the adjoining horizontal floor sections or at most 10 cm underneath the horizontal floor sections. The suction effect generated by the suction slits can then more effectively reach as far as the ridge line of the outer surface.

These and other objects and advantages will be mad apparent from the following brief description of the drawings and the detailed description of the invention.

### BRIEF DESCRIPTION OF THE DRAWINGS

FIG. 1 is a cross-section through an example of implementation of a powder coating cabin according to the invention;

FIG. 2 is a longitudinal section along the line II-II through the powder coating cabin shown in FIG. 1;

FIG. 3 is a horizontal section along the line III-III through the powder coating cabin illustrated in FIG. 1;

FIG. 4 is an enlarged section from FIG. 1

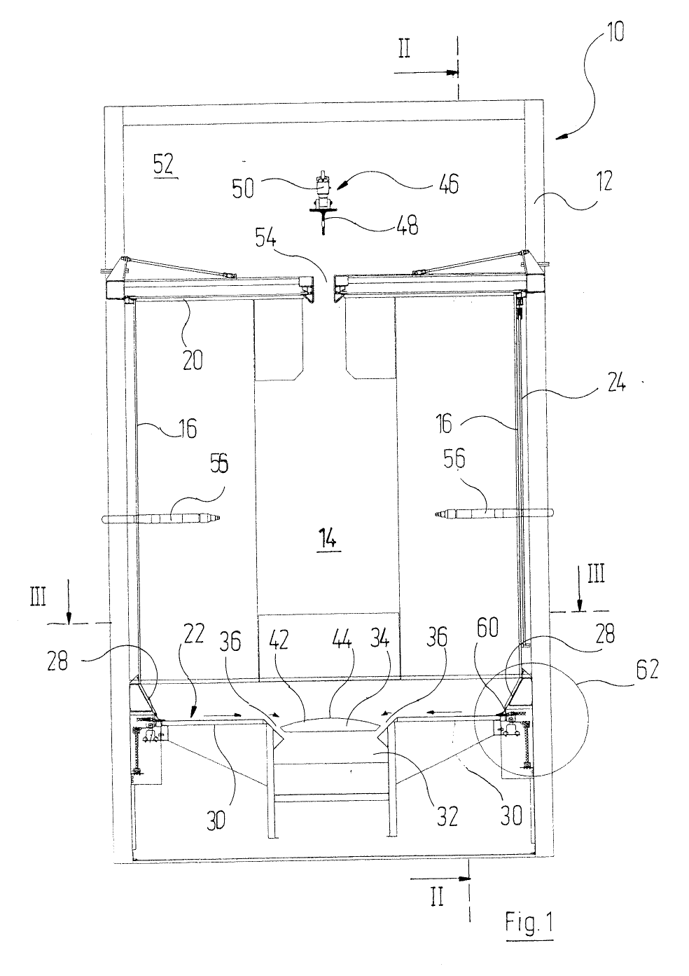

FIGS. 1, 2 and 3 show respectively an example of implementation of a powder coating cabin in a cross-sectional view, a longitudinal section along the line II-II, and a horizontal section along the line III-III.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

The powder coating cabin, identified overall by the reference numeral 10, has a steel structure 12, which is composed of a plurality of horizontally and vertically aligned steel supports. The steel structure 12 carries a plurality of panel-shaped internal cladding elements, which in the present example of implementation are formed as stainless steel sheets and surround an interior 14 of the powder coating cabin 10. The internal cladding is in this connection formed by side walls 16, which extend along a longitudinal direction of the powder coating cabin 10, and by front walls 18, a ceiling 20 and a floor 22.

A sliding door 24 is provided in a side wall 16, in order to allow operating staff access to the interior 14. Doors are also provided on the side walls 18, in order to be able to introduce objects to be coated into the interior 14 and to remove the said objects from the interior 14 after they have been coated.

The floor 22 comprises metal slide-off sheets 28, which join onto the underneath of the side walls 16 and are inclined at an angle of about 50° to the horizontal. Towards the interior, horizontally arranged flat floor sections 30 join onto the two metal slide-off sheets 28, a suction channel 32 extending between the said floor sections along the longitudinal direction of the powder coating cabin 10. The suction channel 32 is covered by a cover hood 34 over such a width that, in the longitudinal direction of the powder coating cabin 10, suction slits 36, 38 are formed between the cover hood 34 and the laterally adjoining horizontal floor sections 30. The cover hood 34 is linked (not shown) along a longitudinal side to a side wall of the suction channel 32 in such a way that the cover hood 34 can be swivelled open, in order to allow access to the suction channel 32.

The cover hood 34 has a convexly curved outer surface 42, the profile of which is symmetrical with respect to the longitudinal direction of the cover hood 34. A ridge line 44 of the curved outer surface 42 is disposed at the same height or just underneath the horizontal floor sections 30.

In order to introduce and remove the objects into and from the powder coating cabin 10, a conveyer 46 is provided, which is designed as a monorail conveyer. The conveyer 46 has for this purpose a carrier rail 48 as well as a travelling gear indicated by the reference numeral 50, which rolls on the carrier rail 48. The conveyer 46 is disposed in a space 52 above the ceiling 20 and thus outside the interior 14. During operation a suspension means carrying the object to be coated is secured to the travelling gear 50, and passes into the interior 14 through a gap 54 in the ceiling.

Two powder spraying devices 56, which can move in the vertical direction along guide rails 58, are disposed in each case on the oppositely facing side walls 16. The powder spraying devices 56 are connected via hose lines (not shown) to a device for supplying the powder coating cabin 10 belonging to the powder coating installation with powder.

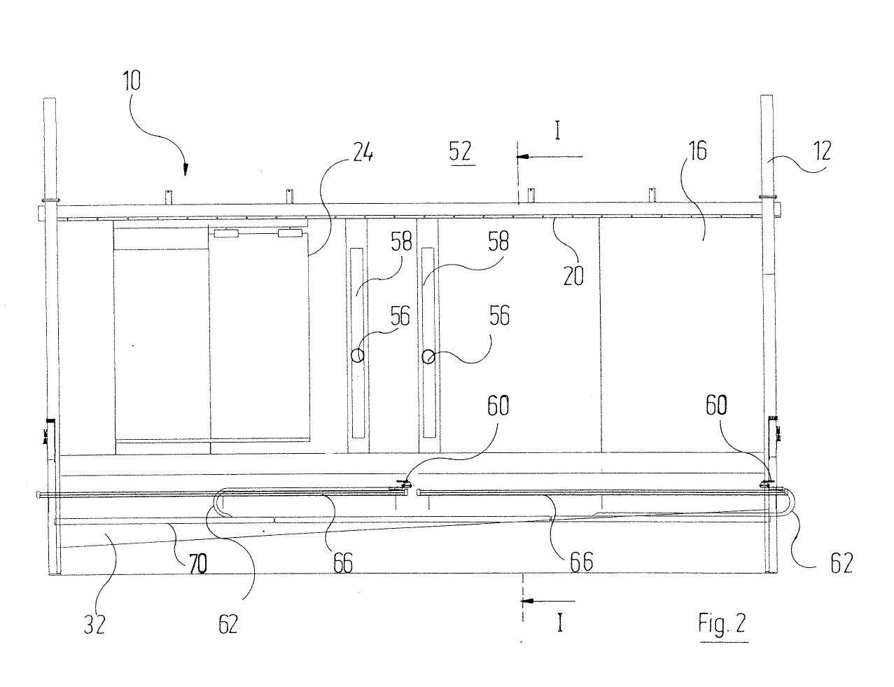

Part of the powder coating installation also comprises a suction fan (not shown), which is connected to the suction channel 32. The suction channel has the task of aspirating fallen excess powder from the interior 14 during the coating procedure, and recycling the powder to a recovery device. The suction channel 32 is of rectangular cross-section, which narrows in the longitudinal direction of the powder coating cabin 10, as can be seen most readily in the longitudinal section of FIG. 2.

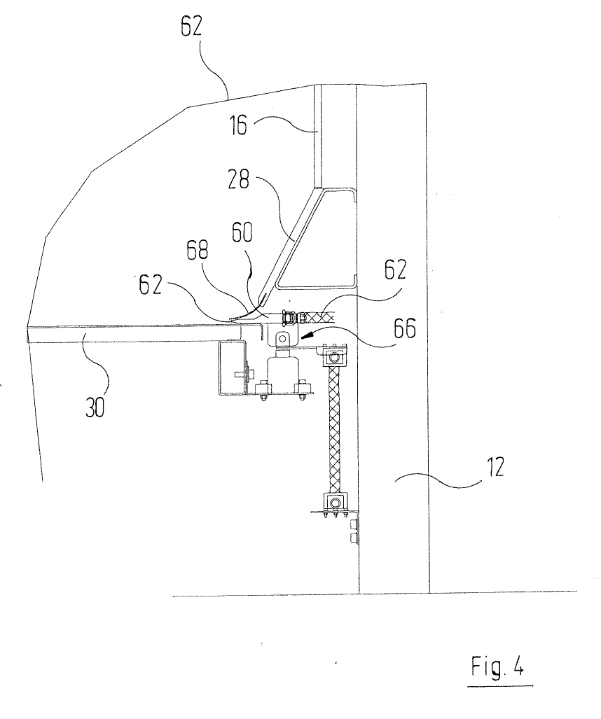

Movable blow-off nozzles 60 are arranged along the longitudinal direction of the powder coating cabin 10 between the metal slide-off sheets 28 and the horizontal floor sections 30, the details of which can best be seen in the enlarged section 62, which is illustrated in FIG. 4. The blow-off nozzles 60 are connected via compressed air hoses 62 to a compressed air machine and have an outlet opening 64 for the compressed air, which is arranged about 2 cm above the adjoining flat floor section 30. To move the blow-off nozzle 60 a drive device 66 is provided, which in the illustrated example of implementation comprises a rail/carriage system. The movement path defined by the drive device 66 runs in each case horizontally underneath the metal slide-off sheet 28. In order to protect the drive device 66 against falling powder, the gap between the metal slide-off sheets 28 on the one hand and the horizontal floor sections 30 on the other hand is in each case covered by an elastic sealing strip 68. When it is moving, the blow-off nozzle 60 forces the sealing strip 68 upwardly apart so that the outlet opening 64 is freed.

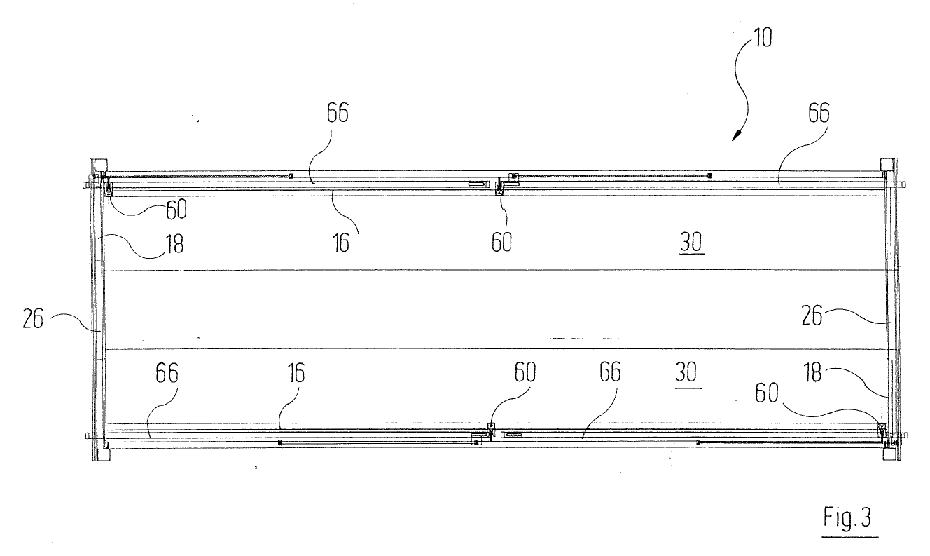

As can best be seen in the horizontal section of FIG. 3, the powder coating cabin 10 has a total of four movable blow-off nozzles 60. In this connection the movement paths of in each case two blow-off nozzles 60 are arranged at the same height behind one another on each longitudinal side of the powder coating cabin 10. The blow-off nozzles 60 are preferably controlled so that the said blow-off nozzles 60 on one side of the powder coating cabin 10 maintain in each case the same distance between one another during a movement operation. It has also been found convenient if, during a movement operation, the movement directions on the two sides of the powder coating cabin 10 are in each case opposite.

In order to permit an unhindered movability of the blow-off nozzles 60, the compressed air hoses 62 are designed as towing devices, which lie in channels 70 during the movement operations. With self-propelled carriages their power supply and control can also be implemented via lines, which together with the compressed air hoses 62 form in each case a common towing device.

The powder coating cabin 10 described hereinbefore functions as follows:

An object to be coated and secured via the suspension over the travelling gear 50 is first of all introduced by means of the conveyer 46 into the interior 14. For this purpose one of the doors 26 on the front side opens briefly in order to allow the object to enter the interior.

The actual coating procedure now starts, during which powder is sprayed from the powder spraying devices 56 onto the introduced object. Since the object is connected to a potential source, most of the sprayed and oppositely charged powder adheres to the object. A relatively small amount of powder however sinks downwardly in the interior. Most of the excess powder is aspirated via the suction slit 36 and conveyed via the suction channel 32 to the recovery unit. A further part of the excess powder settles first of all on the horizontal floor sections 30. Powder which falls onto the inclined metal slide-off sheets 28 slides down these and over the adjoining sealing strips 68 and thereby likewise reaches the flat floor sections 30.

The movable blow-off nozzles 60 are employed to remove powder settling on the horizontal floor sections 30. Preferably during pauses in the coating operation these nozzles are guided along their movement paths through the slit that remains between the inclined metal slide-off sheets 28 and the horizontal floor sections 30. Alternatively or in addition, the blow-off nozzles 60 can also be moved during the coating procedure. The compressed air leaving the outlet openings 64 blows the powder in the direction of the suction channel 32 during the movement operation. The strength of the compressed air flow is in this connection chosen so that the swirled powder is trapped by the reduced pressure prevailing in the suction channel 32 and can be aspirated through the suction slit 36.

As a result of the convex curvature of the outer surface 42, no powder settles on the cover hood 34. The outer surface 42 which falls away towards the longitudinal edges in fact ensures that the suction action generated by the suction slits 36 extends as far as the ridge line 44 of the cover hood 34.

The movement speed of the blow-off nozzles 60 is thus adapted to the width of the horizontal floor sections 30, to the adherence properties between the powder and the floor sections 30 and the suction capacity of the blow-off nozzles 60, so that after passage of the blow-off nozzles the horizontal floor sections 30 are practically completely free of fallen powder. When choosing the length of the movement paths it should be borne in mind that not too much time should elapse between two consecutive passages of the blow-off nozzle 60, in order that the deposited amount of powder can still be largely completely removed by the blow-off nozzle 60.

It is again emphasized that the above-described embodiments of the present invention, particularly, any “preferred” embodiments, are possible examples of implementations merely set forth for a clear understanding of the principles of the invention. Many variations and modifications may be made to the above-described embodiments of the invention without substantially departing from the spirit and principles of the invention. All such modifications are intended to be included herein within the spirit of the invention and the scope of protection is only limited by the accompanying claims.

1. A powder coating cabin for a powder coating installation, with a flat floor section arranged horizontally or inclined and with a blow-off nozzle for blowing off powder that has settled on the floor section, wherein the blow-off nozzle is movably arranged.

2. The powder coating cabin according to claim 1, wherein the blow-off nozzle is movable parallel to the floor section.

3. The powder coating cabin of claim 1, wherein the shortest distance between an outlet opening of the blow-off nozzle and the floor section is less than 5 cm.

4. The powder coating cabin of claim 1, wherein the blow-off nozzle can swivel about a horizontal and/or vertical pivotal axis.

5. The powder coating cabin of claim 1, wherein the blow-off nozzle is movable parallel to a transporting direction towards objects to be coated.

6. The powder coating cabin of claim 5 at least two blow-off nozzles are present, whose movement paths run parallel to one another.

7. The powder coating cabin of claim 1, wherein the movement path of the blow-off nozzle is arranged in a transition region between the floor section and a vertical side wall of the powder coating cabin.

8. The powder coating cabin of claim 1, wherein at least one blow-off nozzle is movably arranged on each longitudinal side of the powder coating cabin.

9. The powder coating cabin of claim 1, wherein the movement path of the blow-off nozzle runs at least approximately in the middle between vertical side walls of the powder coating cabin.

10. The powder coating cabin of claim 1, wherein the blow-off nozzle projects out from a slit at least over a part of the possible movement path.

11. The powder coating cabin of claim 10, wherein the slit is covered by an elastic sealing strip, which can be displaced or penetrated by the blow-off nozzle.

12. The powder coating cabin of claim 10, wherein the slit is formed between floor and wall sections of different inclinations.

13. The powder coating cabin of claim 1, wherein the floor section adjoins a suction channel for aspirating powder, and that the suction channel is arranged relative to a movement path of the blow-off nozzle in such a way that the said blow-off nozzle can blow powder, which has fallen onto the floor section, in the direction of the suction channel.

14. The powder coating cabin of claim 1, wherein the suction channel is to some extent covered over its whole length by a covering in such a way that suction slits remain between the covering and adjoining horizontal floor sections.

15. The powder coating cabin of claim 14, wherein the covering is secured in a tiltable manner.

16. The powder coating cabin of claim 14, wherein the covering has a convexly outwardly curved outer surface.

17. The powder coating cabin of claim 16, further comprising a ridge line of the outer surface runs at the same height as the horizontal floor sections or at most 10 cm underneath the horizontal floor sections.

18. The powder coating cabin of claim 15, wherein the covering has a convexly outwardly curved outer surface.

19. The powder coating cabin of claim 16, further comprising a ridge line of the outer surface runs at the same height as the horizontal floor sections or at most 10 cm underneath the horizontal floor sections.
